(19) United States
(12) Patent Application Publication
(10) Pub. No.: US 2013/0146084 A1
(43) Pub. Date: Jun. 13, 2013

(54) SYSTEM AND METHOD FOR REMOVING OBJECTS FROM SURFACES

(71) Applicants: Dennis D. Wetterich, Newark, IL (US); John M. Teter, North Aurora, IL (US)

(72) Inventors: Dennis D. Wetterich, Newark, IL (US); John M. Teter, North Aurora, IL (US)

(73) Assignee: Caterpillar Inc., Peoria, IL (US)

(21) Appl. No.: 13/313,553

(22) Filed: Dec. 7, 2011

(51) Int. Cl. B08B 7/02; B08B 7/04

(52) U.S. Cl. 134/1; 15/94

(57) ABSTRACT

A system for removing objects from a surface is disclosed. The system may include at least one sensor, a controller, and at least one vibration motor. The sensor is configured to detect an object on the surface and to generate a signal indicative of the object characteristics. The controller may be operatively coupled to the sensor. The controller can receive the generated signal indicative of the object characteristics, and then determine a desired frequency and amplitude of vibration to apply to the surface based on the object characteristics. At least one vibration motor may be in communication with the controller and configured to apply the desired frequency and amplitude of vibration to the surface.

### TECHNICAL FIELD

The present disclosure relates generally to a system and method for removing objects from a surface.

### BACKGROUND

Dirt and debris can collect on surfaces of machines. This can cause such surfaces (e.g., stairs, walkways, and platforms on the machine) that are intended for ingress and egress to become slippery or hazardous to walk on.

Due to stringent regulations regarding safety related to ingress and egress of persons on such various surfaces, it is desirable to provide, among other things, an improved system and method that help to ensure that surfaces remain clean and free of debris and dirt.

A vibrator for a dumping vehicle is disclosed in U.S. Pat. No. 4,175,906 (the '906 patent) issued to Johnston et al. The system disclosed in the '906 patent includes an automatically actuated hydraulically powered vibrator system for loosening the contents of a semi trailer dump body so that it will break away at its natural dumping angle. The semi trailer dump includes a hydraulic pump that delivers hydraulic fluid under pressure to extend a telescoping hydraulic cylinder to raise the dump body to a dumping position. However, such a system can be problematic as the '906 patent requires a surface holding the contents to be raised in order to dump the contents. It is impractical for such a system to work on surfaces that do not tilt (e.g., stationary surfaces, building platforms, etc).

It is therefore desirable to provide, among other things, an improved system and method to remove objects from a surface.

### SUMMARY

In accordance with one embodiment, the present disclosure is directed to a system for removing objects from a surface. The system may include at least one sensor, a controller, and at least one vibration motor. The sensor may be configured to detect an object on the surface and to generate a signal indicative of the object characteristics. The controller may be operatively coupled to the sensor. The controller can receive the generated signal indicative of the object characteristics, and then determine a desired frequency and amplitude of vibration to apply to the surface based on the object characteristics. At least one vibration motor may be in communication with the controller and configured to apply the desired frequency and amplitude of vibration to the surface.

In another embodiment, the present disclosure is directed to a method for removing objects from a surface. The method includes determining the characteristics of an object located on the surface. The method also includes determining a desired frequency and amplitude of vibration to apply to the surface based on the characteristics. The method further includes applying the desired frequency and amplitude of vibration to the surface.

In another embodiment, the present disclosure is directed to a machine for removing objects from a surface. The machine includes a controller configured to monitor objects on the surface. The controller can generate signals indicative of characteristics of the objects. The controller also determines a desired frequency and amplitude of vibration to apply to the surface based on the object characteristics. At least one vibration motor is in operative communication with the controller and configured to apply the desired frequency and amplitude of vibration to the surface.

In yet another embodiment, the present disclosure is directed to a computer-implemented storage device storing instructions for determining vibration patterns to apply to a surface. The instructions may cause one or more computer processors to detect characteristics of an object on the surface, and determine a desired frequency and amplitude of vibration to apply to the surface based on the characteristics. The instructions may further cause the computer processors to apply the desired frequency and amplitude of vibration to the surface, wherein the desired frequency and amplitude of vibration causes the object to be removed from the surface.

### BRIEF DESCRIPTION OF THE DRAWINGS

FIG. 1 illustrates an exemplary disclosed system for removing objects from a surface in accordance with one embodiment.

FIG. 2 illustrates, in flow-chart form, a method for removing objects from a surface according to one embodiment.

### DETAILED DESCRIPTION

Reference will now be made in detail to exemplary embodiments, which are illustrated in the accompanying drawings. Wherever possible, the same reference numbers will be used throughout the drawings to refer to the same or like parts.

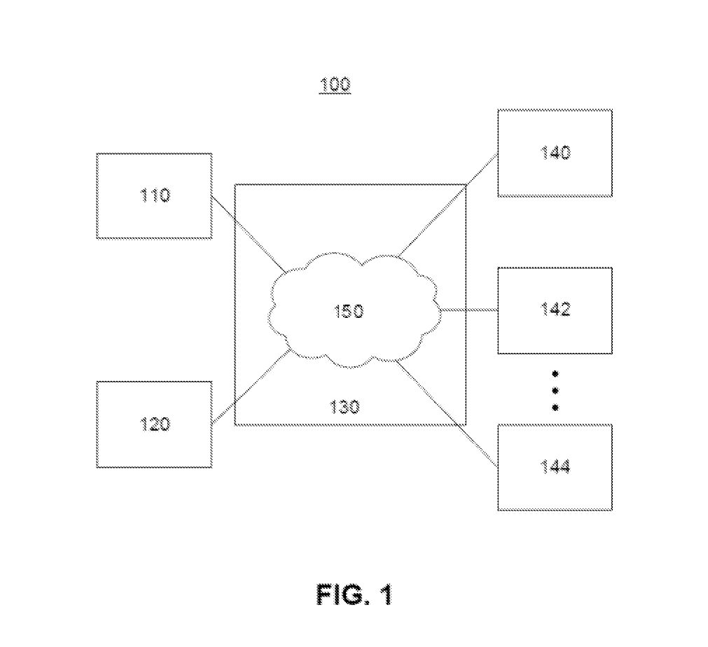

FIG. 1 illustrates an exemplary system 100 for actively self-cleaning a surface in accordance with one embodiment. System 100 may include at least one sensor 110, a controller 120, at least one vibration motor 140, 142 and 144 and a network 150. Sensor 110 can be configured to detect an object on the surface 130 and to generate a signal indicative of the object characteristics. Such signal indicative of the detected object can be sent to the controller 120 via the network 150. The controller 120 may be operatively coupled to the sensor 110. The controller 120 can receive the generated signal indicative of the object characteristics, and then determine a desired frequency and amplitude of vibration to apply to the surface 130. At least one vibration motor 140, 142, 144 may be in communication with the controller 120 to apply the desired frequency and amplitude of vibration to the surface.

In one example, the desired frequency and amplitude of vibration may cause the object to be removed from the surface 130. In another example, the controller 120 can be configured to adjust the frequency and amplitude of vibration applied by the at least one of vibration motor 140, 142, 144 based on signals received from the at least one sensor after changes in object characteristics detected by the at least one sensor. In another example, the controller 120 may include a storage device configured to store information related to the object characteristics and to the desired frequency and amplitude of vibration to apply to the surface 130. In yet another example, the controller 120 can determine a vibration pattern that each of the vibration motors 140, 142, 144 applies to the surface 130. The controller 120 can be configured to select a vibration pattern based on a shape of the surface.

Sensor 110 can be configured to measure displacement, velocity, vibration, environmental weather conditions, thermal conditions, acceleration and/or stress/strain. Such measurements can affect readings detected by the sensor 110 of object characteristics and surface characteristics. As such, exemplary sensors that can be used include, for example, piezoelectric accelerometers, acoustic/sound/vibration sensors; position sensors, heat flux sensors, hygrometers, accelerometers, capacitive displacement sensors, etc. One or more of these sensors can be used in different combinations to achieve a desired measurement requirement. The sensor 110 may be mounted on the surface 130 and can be located proximate to an object that is to be vibrated.

The sensor 110 may be tuned with software to recognize various conditions of the surface and object. As an example, the sensor 110 can be configured to recognize conditions under which a surface 130 is clean (e.g., when there is no object on the surface 130), as well as conditions under which the surface 130 can be deduced as dirty (e.g., when the surface is covered with objects). As used herein, an object refers to materials such as dirt and debris that are unwanted on a surface 130. Different objects may absorb different amounts of energy. The sensor 110 can be configured to detect an object on the surface 130 as well as characteristics of the object. Such characteristics can include, for example, amounts of energy absorbed by the object. Controller 120 can then determine a frequency and amplitude of vibration that is suitable to move the object away from the surface based on such energy absorbed by the object.

Therefore, sensor 110 may operate to detect if an object is present on the surface 130. If an object is present on the surface 130, the sensor can generate a signal indicative of the characteristics of such objects found on the surface 130. The sensor 110 can then communicate with a controller 120 to enable the controller 120 to determine frequency and amplitude combination(s) to communicate to the vibration motors 140, 142, 144 to apply to the surface 130.

Any of the vibration motors 140, 142, 144 can be configured as, for example, a linear actuator to induce vibration. Such linear actuator can create linear vibratory motion along the surface 130. Although three vibration motors 140, 142, 144 are disclosed herein, it is recognized that, in alternative embodiments, a single vibration motor (i.e., any one of vibration motors 140, 142, 144) can be used to achieve desired results in system 100. Vibration motor 140, for example, can be located on the surface 130 and at some distance away from objects on the surface. The vibration motor 140 can then apply vibrations to the surface 130 based on instructions received from the controller 120.

Vibration motors 140, 142, 144 may implement vibrations in a variety of patterns e.g., circular patterns, elliptical patterns, linear patterns, random patterns, etc. Depending on the shape of the surface 130, the controller 120 can determine which vibration pattern that vibration motors 140, 142, 144 may emit along the surface to vibrate an object or debris. In certain situations, an instrument or device of a desired shape can be added to the surface 130 to induce a desired vibration pattern. As one example, a linear striker can be added to the surface 130. Vibration motors 140, 142, 144 can then be controlled to run at selected frequencies. The linear striker can cause the vibrations from the vibration motors 140, 142, 144 to transmit in a linear manner. This can be effective on some certain surfaces depending on the shapes of those surfaces. Other instruments or devices having different alternative shapes can be used. As an example, a circular plate can be placed on the surface 130 to further optimize vibration flow paths along the surface 130.

According to various alternative embodiments, vibration motors 140, 142, and 144 may be configured to emit vibration patterns in parallel. For example, vibration motor 140 may receive an input file for a first vibration pattern, vibration motor 142 may receive an input file for a second vibration pattern, etc., and each vibration motor may emit a vibration pattern independently of any other vibration motor. Further, vibration motors 140, 142, and 144 each may also be configured to process a particular vibration pattern in parallel, e.g., using multiple processors. When a vibration motor completes its vibration, any of vibration motors 140, 142, and/or 144 may send the results of the vibration to controller 120. The results may include, e.g., frequencies and amplitudes of vibrations emitted, duration of vibration, vibration patterns emitted, directions of the emitted vibration patterns at one or more locations on the surface 130, etc. This may enable the controller 120 to verify whether each of the vibration motor performed its tasks as required.

In alternative embodiments, vibration motors 140, 142, 144 can be used to determine whether an object is present on a surface 130. For example, vibration motors 140, 142, 144 can be mounted in an “out of balance” configuration to create an intermittent load on the surface 130. The out-of-balance vibration motors 140, 142, 144 can be activated by an external source such as electrical or fluid power (e.g., hydraulic oil, air, water, etc) to generate frequencies and amplitudes that can then be applied to objects present on the surface 130. The controller 120 can then determine how much dampening is occurring between the vibration motors 140, 142, 144 and the sensor 110 by comparing the frequency and amplitude applied to the object from the external source with the frequency and amplitude as determined by controller 120 (based on the object characteristic signal generated by sensor 110 related to the object). Such dampening of the frequency and/or amplitude of vibration can be attributed to other objects (e.g., debris/foreign material) on the surface 130, or a failure of the surface 130 (e.g., a crack).

Alternatively, vibration motors 140, 142, 144 can be configured with an internal sensor or feedback loop such that the controller 120 can determine amounts of energy required to create specific frequencies and amplitudes of vibration. If more energy is required, then the presence of dampening agents such as objects on the surface can be deduced. If normal energy was needed to create vibration, then it can be deduced that little or no objects are present on the surface. At some natural frequency, objects (e.g., debris) attached to the surface 130 may breakup and shake off, especially if the surface 130 is slanted. The shake-off of objects from the surface 130 can lessen the dampening effect measured on such surface.

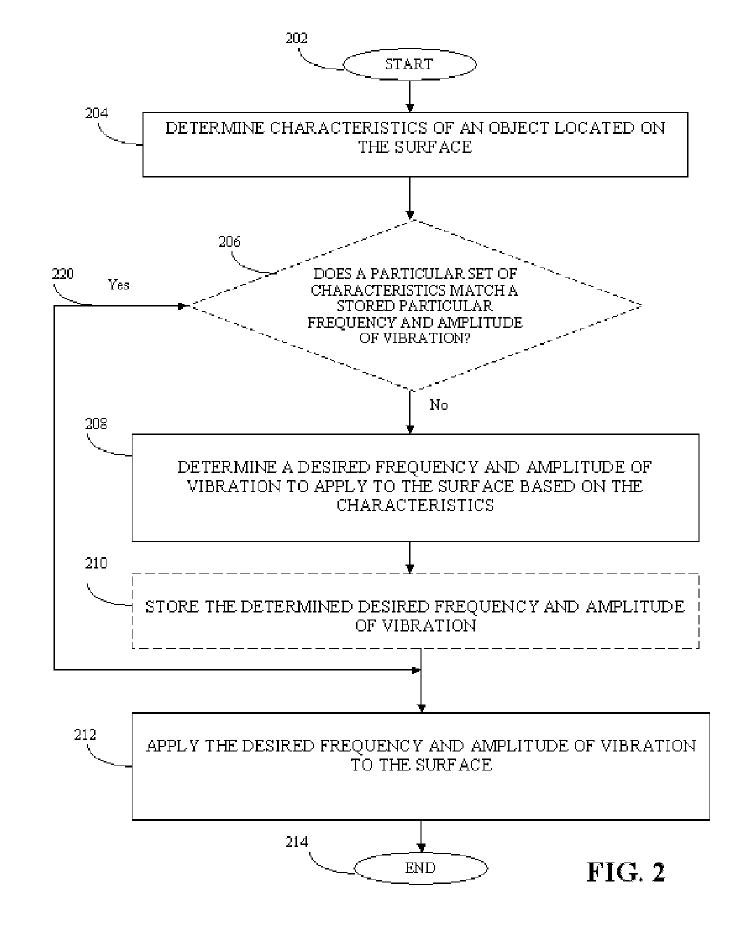

Controller 120 may be any device capable of receiving signals from a sensor 110 indicative of characteristics of a detected object and determining a desired frequency and amplitude of vibration. According to various alternative embodiments, controller 120 may include a processor, a memory, and storage device (not shown). The memory may include one or more programs loaded from storage or elsewhere that, when executed by the processor, enables the controller 120 to perform various procedures, operations, or processes consistent with the disclosed embodiments, including the processes described in FIG. 2. The storage may store workload-balancing software that enables the controller 120 to send input files to vibration motors 140, 142, 144 in a way that balances workloads among them. In some embodiments, the storage may store information and data that may be used by controller 120 to generate input files, and then send such input files to any of vibration motors 140, 142, 144.

In some embodiments, the controller 120 and the sensor 110 may be implemented as a single device e.g., a computer running software that enables the computer to perform one or more of the functions related to different embodiments of sensor 110 and controller 120, as discussed above. In other embodiments, controller 120 may be included in one of the vibration motors 140, 142, 144, e.g., causing one the vibration motors 140, 142, 144 to act as a master and the remaining vibration motors 140, 142, 144 to act as a slave.

The controller 120 can receive feedback of characteristic information of objects on the surface. Such characteristic information that may result due to the presence or absence of objects on the surface 130 can enable the controller 120 to make a determination as to whether the surface is “clean” or “dirty”.

As such, the controller 120 can be configured to continuously receive feedback of various object characteristics detected by the sensor 110. This continuous feedback can enable the controller 120 to be tuned so as to further remember or learn what combinations worked in the past, and then use such information as a basis to determine vibration patterns to send to the surface 130 for other similar objects that may be present on the surface 130. This can be useful especially in situations where a truck or machine operates in a similar type of environment (e.g., mining site, quarry site, construction worksite, etc.) over a long time period. By recognizing object characteristics of various types of objects and associating those characteristics with successful actions taken in the past when similar object characteristics were detected, the controller 120 may better optimize the vibration frequencies and amplitudes that vibration motors 140, 142, 144 emit on the surface 130 to cause a given object to be vibrated off the surface 130.

The controller 120 may store in memory various frequency and amplitude combinations associated with a variety of object characteristics. Such memory can be located within the controller 120 or can be a storage device separate from the controller 120. The controller 120 may also store various conditions under which objects are removed from the surface 130 (i.e., achieved active self-cleaning) Such conditions can include, but are not limited to, surface friction, surface composition, as well as surface temperature, dryness, wetness, moisture etc. Other conditions that the controller 120 may store can be object conditions (such as whether the object is dry, wet, frozen, moist etc), atmospheric weather conditions (e.g., weather temperatures, pressure, humidity etc) during which the surface 130 was self-cleaned. For a given object type, the controller 120 may utilize the last stored frequency and amplitude when determining which frequencies and amplitudes to apply to another similar object, and then may attempt other stored frequency and amplitude combinations for other similar objects in order to decipher an optimal frequency and amplitude combination to utilize in moving objects off the surface 130.

The controller 120 can be configured to be manually or automatically activated. As an example, the controller 120 can recognize energy outputted by an object to facilitate the controller 120 to turn-off or turn-on based on some dealer and/or manufacturer prescribed time lapse. The controller 120 can also be configured to periodically turn-on so as to periodically check for dampening objects present on a surface.

As described supra, in system 100, communications among the various component parts (i.e., sensor 110, controller 120, vibration motors 140, 142, 142) may be occur over a network 150. Such network 150 may include any one of or combination of wired or wireless networks. For example, network 150 may include wired networks such as twisted pair wire, coaxial cable, optical fiber, and/or a digital network. Likewise, network 150 may include any wireless networks such as RFID, microwave or cellular networks or wireless networks employing, e.g., IEEE 802.11 or Bluetooth protocols. Additionally, network 150 may be integrated into any local area network, wide area network, campus area network, or the Internet.

### INDUSTRIAL APPLICABILITY

The disclosed system 100 may be applicable to any machine or platform that requires its surface to be actively cleaned on a regular basis. As one example, the system 100 may be a component of a large mining truck, a wheel loader, a track loader, an excavator, farm equipment, building platforms, grain storage facilities, high-rise personnel platforms, building roofs, etc. The operation of the system 100 will now be explained in connection with the flowchart of FIG. 2.

FIG. 2 illustrates in flow-chart form a method for removing objects from a surface according to one embodiment. The method starts in operation 202. In operation 204, a controller 120 may determine characteristics of an object located on the surface 130. In one embodiment, if desired, the controller 120 can be configured to determine if a particular set of characteristics match a stored particular frequency and amplitude of vibration, in operation 206. If there is a match, the method proceeds to operation 212 (described below). If there is no match, the controller 120 can determine a desired frequency and amplitude of vibration to apply to the surface 130 based on the object characteristics, in operation 208. In operation 210, if desired, the desired frequency and amplitude of vibration is stored in memory. Such memory may be embedded with or can be separate from the controller 120. The controller 120 may utilize stored frequencies and amplitudes of vibration when determining which frequencies and amplitudes to apply to another similar object, and then may attempt other stored frequency and amplitude combinations for other similar objects in order to decipher an optimal frequency and amplitude combination to utilize to move objects away from the surface 130. This process can be repeated via a feedback loop 220. As such, the controller 120 can learn vibration patterns to instruct vibration motors 140, 142, 144 to apply to the surface based on matching a particular set of characteristics with stored frequencies and amplitudes of vibration of similar objects. In operation 212, the controller 120 may apply the desired frequency and amplitude of vibration to the surface 130. Such frequency and amplitude of vibration can cause objects to be removed from the surface 130.

The vibration motors 140, 142, 144 can be used in various configurations. For example, vibration motors 140, 142, 144 can be mounted at different locations on steps/stairs of an off-highway truck. The stairs can be placed or constructed at a slight angle. Vibration motors 140, 142, 144 can be placed at various locations of the staircase such that vibrations from the motors 140, 142, 144 can cause dirt, debris or objects that are disposed on the staircase to be moved or displaced along the steps in directions that are based on the vibration patterns of the vibration motors 140, 142, 144, as well as the tilt angle of the steps. When the sensor 110 detects an amount of debris or dirt on the steps, the controller 120 may be configured to control the vibration motors 140, 142, 144 to vibrate the steps. The controller 120 may also determine vibration patterns that may be used by each of the vibration motors 140, 142, 144 to optimally remove the debris/dirt/object from each step. The frequency of vibration can be dependent on the amount and type of debris/dirt/object collected on the surface to be cleaned. As an example, the controller 120 can determine the best frequency and amplitude to apply to coal dust resting on a machine, or the best frequency and amplitude of vibration to apply to a machine to move lime dust off a machine surface located in a limestone quarry. Generally, larger machines (e.g., mining trucks) may be placed in a specific location (e.g., mine, quarry, etc), wherein the objects that the mining truck operates on or regularly encounters remain fairly consistent. In such an environment, the controller 120, via its associated software, may be configured to control the vibration motors 140, 142, 144 based on a pre-configured identification of object characteristics present in such an environment. This is because the appropriate frequencies may already be known for certain objects, and can then be preprogrammed for future use. As such, the controller 120 may be better able to predict which frequency and amplitudes may be needed for a given machine at a given site.

The controller 120 can also be configured to generate an alert (e.g., a warning sound, light, vibration, or display) to alert persons or animals when the system 100 is about to start its cleaning process. The system 100 can be configured to cause a delay from when the signal is generated to when the cleaning process actually starts. Such alert and delay can serve as a safety mechanism to alert a person or animal in proximity to the system 100 to make them aware of objects/debris that may potentially fall off the platform or machine using the system 100.

The vibration motors 140, 142, 144 may generate vibrations by using, for example, a hydraulic unbalanced spinning weight (similar to vibrating rollers used in paving products), or by using an electrical magnetic drive, or by using an unbalanced hydraulic pump. Other exemplary ways to generate vibrations include using the vibration from the engine, a linear actuator, the natural motion/energy from the machine to excite the walking surface, and/or using tire pressure fluctuations. The vibrations can be activated intermittently, as determined by the controller and the object characteristics. Although the controller 120 can be configured to automatically and/or remotely determine when to activate the vibration motors 140, 142, 144 to remove debris/dirt/objects from a surface 130, it is understood that system 100 may be configured to operate manually. In this manner, the operator via the cab console, for example, can trigger vibration frequencies and amplitudes from the vibration motors 140, 142, 144 manually.

While this disclosure includes particular examples, it is to be understood that the disclosure is not so limited. Numerous modifications, changes, variations, substitutions and equivalents will occur to those skilled in the art without departing from the spirit and scope of the present disclosure upon a study of the drawings, the specification and the following claims.

What is claimed is:

1. A system for removing objects from a surface, comprising:
at least one sensor configured to detect an object on the surface and to generate a signal indicative of the object characteristics;
a controller operatively coupled to the sensor and configured to:
receive the generated signal indicative of the object characteristics, and
determine a desired frequency and amplitude of vibration to apply to the surface based on the object characteristics; and
at least one vibration motor in communication with the controller and configured to apply the desired frequency and amplitude of vibration to the surface.

2. The system of claim 1, wherein the desired frequency and amplitude of vibration applied to the surface causes the object to be removed from the surface.

3. The system of claim 1, wherein the controller is configured to adjust the frequency and amplitude of vibration applied by the at least one vibration motor based on signals received from the at least one sensor after changes in object characteristics detected by the at least one sensor.

4. The system of claim 1, wherein the controller comprises a storage device configured to store information related to the object characteristics and to the desired frequency and amplitude of vibration to apply to the surface.

5. The system of claim 1, wherein the controller is configured to determine a vibration pattern that the at least one vibration motor applies to the surface.

6. The system of claim 5, wherein the controller is configured to select a vibration pattern based on a shape of the surface.

7. A method for removing an object from a surface, comprising:
determining the characteristics of an object located on the surface;
determining a desired frequency and amplitude of vibration to apply to the surface based on the characteristics; and
applying the desired frequency and amplitude of vibration to the surface.

8. The method of claim 7, wherein the desired frequency and amplitude of vibration applied to the surface causes the object to be removed from the surface.

9. The method of claim 7, further comprising:
associating a particular set of characteristics with a particular frequency and amplitude of vibration.

10. The method of claim 9, further comprising:
determining whether the characteristics are associated with a particular frequency and amplitude of vibration.

11. The method of claim 7, further comprising:
monitoring the characteristics to detect any changes in the characteristics; and
adjusting the frequency and amplitude of vibration based on changes in the characteristics.

12. The method of claim 7, further comprising:
determining a vibration pattern to apply to the surface.

13. A machine for removing an object from a surface, comprising:
a controller configured to:
monitor objects on the surface,
generate signals indicative of characteristics of the objects, and
determine a desired frequency and amplitude of vibration to apply to the surface based on the object characteristics; and
at least one vibration motor in operative communication with the controller and configured to apply the desired frequency and amplitude of vibration to the surface.

14. The machine of claim 13, wherein the desired frequency and amplitude of vibration applied to the surface causes the object to be removed from the surface.

15. The machine of claim 13, wherein the controller is further configured to adjust the frequency and amplitude of vibration applied by the at least one vibration motor based on feedback received under different conditions of the surface and the object characteristics.

16. A computer-implemented storage device storing instructions for determining vibration patterns to apply to a surface, the instructions causing one or more computer processors to perform operations comprising:
detecting characteristics of an object on the surface;
determining a desired frequency and amplitude of vibration to apply to the surface based on the characteristics; and
applying the desired frequency and amplitude of vibration to the surface, wherein the desired frequency and amplitude of vibration causes the object to be moved in directions away from the surface.

17. The computer-implemented storage device of claim 16, wherein the desired frequency and amplitude of vibration are determined based on the object characteristics.

18. The computer-implemented storage device of claim 16, further comprising:
storing information related to an association of the characteristics with the desired frequency and amplitude of vibration to apply to the surface.

19. The computer-implemented storage device of claim 16, further comprising:
determining a vibration pattern to apply to the surface to remove the object from the surface.

20. The computer-implemented storage device of claim 19, wherein the vibration pattern is based on a shape of the surface.
